(19) United States
(12) Patent Application Publication
(10) Pub. No.: US 2020/0208914 A1
(43) Pub. Date: Jul. 2, 2020

(54) A DRYING SYSTEM, A METHOD AND A COMPUTER PROGRAM PRODUCT

(71) Applicant: Rhino Research Europe B.V., Aalten (NL)

(72) Inventor: Johan Gaston Marie VAN ASBROUCK, Phichit (TH)

(21) Appl. No.: 16/495,443

(22) PCT Filed: Mar. 21, 2018
(86) PCT No.: PCT/NL2018/050177

§ 371 Date: Sep. 19, 2019

(30) Foreign Application Priority Data
Mar. 21, 2017 (EP) 17162164.2

(51) Int. Cl. F26B 25/00; F26B 3/06

(52) U.S. Cl. CPC F26B 25/002; F26B 21/083; F26B 3/06

(57) ABSTRACT

The invention relates to a drying system. The drying system comprises a drying chamber including a bead compartment for accommodating bead particles, a drying compartment and a gas permeable partitioning separating the bead compartment from the drying compartment. The drying compartment may include a product compartment for accommodating a product to be dried. The drying chamber further includes a bead inflow opening for flowing dry bead particles into the bead compartment and a bead discharge opening for flowing saturated bead particles from the bead compartment outwardly.

### FIELD OF THE INVENTION

The invention relates to a drying system for drying a product.

### BACKGROUND OF THE INVENTION

Drying products such as agricultural products, e.g. seeds and/or grain, is crucial for a wide variety of products and product related processes. As an example, the quality and the longevity, very important factors for profitability for each seed business, are enormously influenced by drying.

Especially in areas with high ambient temperatures and/or high air moisture contents, such as in Asia, the non-trivial issue of drying and storing seeds is even a higher challenge.

Investment costs for adequate drying and storage systems are high. Further, the exploitation of such drying and storage systems suffer from irregular and unpredictable performance. Energy costs are soaring and are adding another challenging dimension to drying and storing seeds. In addition, adequate resources and infrastructure are often not available in those environments where seed drying and storage facilities are definitely needed.

Generally, the application of beads for drying seeds is a promising technology due to their drying performance and its nearly unending intrinsic regeneration possibilities. However, it appears in practice that a process of regenerating beads is labor intensive, time consuming and potentially unpredictable in view of operational parameters. Interruptions of the drying process have a negative influence, e.g. in terms of quality and homogeneity of the drying process and the dried product, especially for big bulk commodities.

### SUMMARY OF THE INVENTION

It is an object of the present invention to provide an improved drying system for drying a product. Thereto, the drying system comprises a drying chamber including a bead compartment for accommodating bead particles, a drying compartment and a gas permeable partitioning separating the bead compartment from the drying compartment, wherein the drying chamber further includes a bead inflow opening for flowing dry bead particles into the bead compartment and a bead discharge opening for flowing saturated bead particles from the bead compartment outwardly.

By providing the bead compartment with a bead inflow opening and a bead discharge opening the amount of bead particles present in the bead compartment can be timely refreshed thereby enabling a continuous drying functionality. Bead particles that have reached a relatively high saturation level, i.e. a relatively high humidity level, can be discharged from the bead compartment while fresh bead particles having a relatively low saturation level, i.e. a relatively low humidity level can be supplied into the bead compartment maintaining a drying performance level, thereby providing a dryer system that may operate continuously, e.g. for drying big bulk commodities.

The invention also relates to a drying method.

Further, the invention relates to a computer program product. A computer program product may comprise a set of computer executable instructions stored on a data carrier, such as a flash memory, a CD or a DVD. The set of computer executable instructions, which allow a programmable computer to carry out the method as defined above, may also be available for downloading from a remote server, for example via the Internet.

Further advantageous embodiments according to the invention are described in the following claims.

### DESCRIPTION OF THE DRAWINGS

By way of example only, embodiments of the present invention will now be described with reference to the accompanying figures, in which

FIG. 1 shows a schematic view of a first embodiment of a drying system according to the invention;

FIG. 2 shows a schematic view of a second embodiment of a drying system according to the invention;

FIG. 3 shows a schematic partial of a third embodiment of a drying system according to the invention, and

FIG. 4 shows a flow chart of steps of a method for drying a product according to the invention.

It is noted that the figures show merely preferred embodiments according to the invention. In the figures, the same reference numbers refer to equal or corresponding parts.

### DETAILED DESCRIPTION OF THE INVENTION

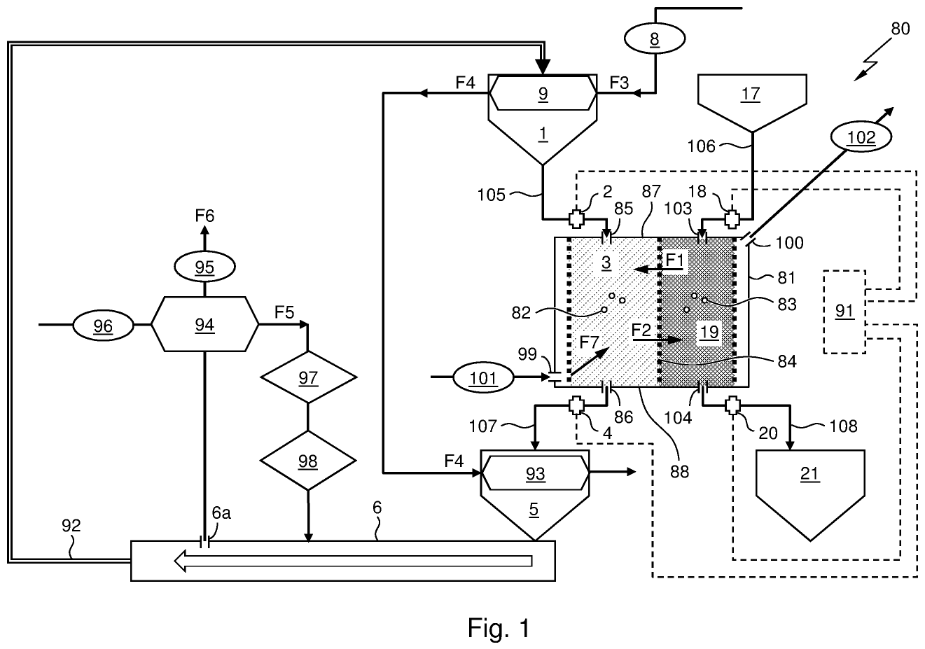

FIG. 1 shows a schematic view of a first embodiment of a drying system 80 according to the invention. The drying system 80 is arranged for drying a product such as solid particles, e.g. seeds, grain and other commodities, split peas or nuts, or a gas such as humid air, e.g. for the purpose of drying air that is flown through agricultural products such as seeds. Generally, the drying system lowers a moisture or humidity level of the product to be dried. By reducing an amount of moisture in or on the product a higher dryness degree of said product is obtained. The moisture may include an absolute mount or a density of evaporated and/or condensed water.

The drying system 80 is provided with a drying chamber 81 including a bead compartment 3 for accommodating bead particles 82, a product compartment 19 for accommodating a product 83 and an gas permeable partitioning 84 separating the bead compartment 3 from the product compartment 19. Further, the drying chamber 81 includes a bead inflow opening 85 for flowing dry bead particles into the bead compartment 3 and a bead discharge opening 86 for flowing saturated bead particles from the bead compartment 3 outwardly.

During operation of the drying system 80 gas exchanges through the gas permeable partitioning 84. Then, a moistened gas flow F1 may flow from the product compartment 19 through the gas permeable partitioning 84 into the bead compartment 3 where the gas is dried by the bead particles 82. Also, a dry gas flow F2 may flow from the bead compartment 3 through the gas permeable partitioning 84 into the product compartment 19 thereby drying the product 83. Preferably, the thickness of the bead compartment 3 and the product compartment 19 in a direction transverse to the orientation of the gas permeable partitioning 84 is relatively small, thereby optimizing homogeneity in the drying process of the product on the one hand and in the water absorbing process of the beads on the other hand. As an example, the thickness of the bead compartment 3 and the product compartment 19 can be in a range from circa 5 cm to circa 20 cm, more preferably in a range from circa 10 cm to circa 15 cm. Generally, the drying chamber functions as a kind of gas flow exchanger transporting a net humidity amount from the product chamber 19 towards the bead compartment 3.

By providing the bead compartment 3 with a bead inflow opening 85 and a bead discharge opening 86 the amount of bead particles 82 present in the bead compartment 3 can be timely refreshed thereby enabling a continuous drying functionality. Bead particles that have reached a relatively high saturation or moisture level can be discharged from the bead compartment 3 while fresh bead particles having a relatively low saturation or moisture level, relative to the saturation level of the beads to be discharged, can be supplied into the bead compartment 3 maintaining a drying performance level. Generally, the moisture level of the beads accumulates during their stay in the bead compartment 3.

In the embodiment shown in FIG. 1, the bead inflow opening 85 is located near the a top 87 of the bead compartment 3 and the bead discharge opening 86 is located near a bottom 88 of the bead compartment 3, so that the bead flow may be induced by gravity, thereby saving active bead flow enforcing means such as conveyer belts. However, in principle, the bead inflow opening 85 and the bead discharge opening 86 can be arranged at other locations on the bead compartment 3.

The shown system 1 further comprises a bead flow control mechanism for controlling a bead inflow through the bead inflow opening 85 and a bead outflow through the bead discharge opening 86. The bead flow control mechanism includes a bead inflow valve 2 arranged upstream to the bead inflow opening 85, a bead discharge valve 4 arranged downstream to the bead discharge opening 86, and a control unit 91 operating the bead valves 2, 4.

The bead valves 2, 4 can be implemented as revolving sluices having the advantage that a gastight construction can be provided so that any interaction between bead particles and surrounding air is minimized.

Preferably, the control unit 91 is programmable to set a desired level of bead particles in the bead compartment 3. Then, the control unit 91 can be arranged to control the set level of bead particles by regulating a bead flow into the bead compartment 3, i.e. by timely opening and closing, respectively, the bead inflow valve 2. In a specific embodiment, the bead inflow valve can be free flowing such that the bead compartment 3 is always completely filled.

Similarly, the control unit 91 may be programmable to set a desired saturation degree of discharged particles. Then, the control unit 91 can be arranged to control the set saturation degree of discharged particles by regulating a bead discharge flow, i.e. by timely opening and closing, respectively, the bead discharge valve 4. Then, the beads can be used in a cost efficient manner. As an example, the bead discharge flow can be reduced when the beads have not reached the set saturation degree. In a specific embodiment, the bead discharge valve is speed controlled such that the beads are used sufficiently, but remain active until reaching the bottom of the bead compartment.

The desired level of bead particles in the bead compartment 3 and/or the desired saturation degree of discharged particles can be set by the customer, e.g. by selecting a value from a pre-programmed discrete number of values or by choosing a value in a range of values between pre-programmed boundaries. Further, the desired bead particles level and/or the desired saturation or humidity degree of discharged particles can be set by pre-programming, e.g. to standard values.

The control unit 91 can be arranged to regulate flows in different manners, e.g. as a continuous or quasi-continuous bead inflow and/or bead discharge flow, or as an inflow and/or discharge flow in batches, i.e. by repeatedly interrupting the respective flow.

Advantageously, the bead inflow and/or the bead discharge flow can be performed automatically by programming the control unit 91 and by forwarding sensor data to said control unit 91. Thereto, the drying system 80 may advantageously include a sensor sensing the height or level of bead particles in the bead compartment 3, e.g. by sensing the weight of the bead particles, as well as a sensor sensing a saturation degree of discharged particles, e.g. by sensing the temperature of bead particles in the bead compartment 3 or just after being discharged from the bead compartment 3. It is noted that, in principle, the bead inflow and/or the bead discharge flow can be performed manually by an operator operating the bead inflow valve 2 anchor the bead discharge valve 4, e.g. in case of high value products to be dried.

By controlling a desired level of bead particles in the bead compartment 3 and a desired saturation degree of discharged bead particles, a perfect control on drying and homogeneity of the drying process can be obtained.

The system 80 shown in FIG. 1 further comprises a dry bead container 1, also called dry bead hopper or closed bead silo, arranged upstream to the bead inflow opening 85, as well as a saturated bead container 5, also called wet bead hopper, arranged downstream to the bead discharge opening 86. By providing upstream and downstream hoppers 1, 5 a continuous drying process can be facilitated and automated more easily. The dry bead hopper 1 can be refilled batchwise or in a continuous manner. Similarly, the wet bead hopper 1 can be discharged batchwise or in a continuous manner. Instead of applying upstream and downstream hoppers 1, 5 other mechanisms can be applied to supply and discharge beads into and from the bead compartment 3, e.g. using conveyer belts.

The shown system 80 also comprises a bead generator device 6 such as an open belt dryer arranged downstream to the saturated bead hopper 5. The bead generator device 6 can be implemented as a low cost dryer. Then, the saturated beads discharged from the bead compartment 3 can be regenerated, inline, ready for re-use. Generally, the moisture level of the beads reduces during their stay in the bead generator device 6. The beads from the saturated bead hopper 5 can be removed in an alternative way, e.g. by filling buckets and removing said buckets manually. Preferably, the bead generator device 6 processes the saturated beads batch-wise, thereby increasing the system efficiency and safety, e.g. by operating at night when energy is cheap or operating at day when human control is cheaper.

Advantageously, the system 80 further comprises a feedback line 92 transporting regenerated beads form the bead regenerator device 6 to the dry bead hopper 1. Then, a closed loop is formed as the regenerated beads can be flown into the bead compartment 3, via the bead inflow opening 85, as described above. By providing the feedback line 92 a stand-alone closed loop drying system 80 is provided enabling a drying process of wet products in a continuous, efficient, cost-effective and robust manner. The drying system 80 is an excellent tool for drying big bulk product such as commodities, e.g. seeds, optionally within a relatively narrow temperature range, e.g. at a maximum temperature between circa 30 degrees Celsius and circa 60 degrees Celsius, e.g. circa 38, 45 or 50 degrees Celsius. If desired the drying system 80 can be arranged for drying at a higher temperature or temperature range, e.g. above 60 degrees Celsius such as at a temperature of circa 70, 80 or 90 degrees Celsius, e.g. depending on a user-specified outcome result. As an example, a process of drying a product such as nuts can be combined with a roasting process. Generally, the temperature of beads raises when absorbing water due to an exothermic reaction. Further, for the purpose of regenerating the beads said beads are heated externally such that the beads are dried, ready for a new cycle of drying wet products by absorbing moisture from humid air that is flown to the bead compartment. By applying the feedback structure of the system shown in FIG. 1 the temperature of the beads should not drop below a pre-defined temperature, e.g. circa 150 degrees Celsius, unless desired otherwise, thereby increasing the efficiency of the drying process significantly.

In the system 80 shown in FIG. 1 the dry bead container 1 is provided with a first heat exchanger 9 for cooling the dry beads, using a gas flow. Here, the system includes a first fan 8 inducing a gas flow F3, e.g. a flow with ambient air, towards the first heat exchanger 9. The gas flow F3 cools the dry beads in the upstream hopper 1 while the gas flow itself is heated up. The cooling capacity of the first heat exchanger 9 may depend on the dimensions of the dry bead container 1, the amount of beads in the dry bead container 1 and other parameters such as the gas flow rate. By cooling the dry beads before being fed into the bead compartment 3, the system 80 is more apt to process temperature sensitive products.

Similarly, the saturated bead container 5 in the system shown in FIG. 1 is provided with a second heat exchanger 93 for heating the saturated beads using an exhausted gas flow F4 exhausted from the first heat exchanger 9, so that the heat from the regenerated beads present in the upstream hopper 1 is used to pre-heat the saturated beads in the downstream hopper 5.

It is noted that, in principle, the drying system 80 can be implemented without the second heat exchanger 93, and also without the first heat exchanger 9. Then, a more simple system is obtained. The system shown in FIG. 1 includes a third heat exchanger 94 for pre-heating a feeding gas flow F5 for feeding the bead regenerator device 6, using a heated gas flow F6 flowing from the bead regenerator device 6. Thereto, the system 80 includes a second fan 95 for inducing the heated gas flow F6 to flow from a gas exhaust section 6a of the bead regenerator device 6 towards and through the third heat exchanger 94 for pre-heating the feeding gas flow F5. Similarly, the system 80 includes a third fan 96 for inducing the feeding gas flow F5 towards and through the third heat exchanger 94 to be pre-heated by the heated gas flow F6, thereby exploiting the gas exhausted from the bead regenerator device 6, after regenerating beads, for pre-heating the feeding gas flow F5 to be used for regenerating the beads. The feeding gas flow F5 is a fresh, ambient air flow.

It is noted that, in principle, the drying system 80 can be implemented without the third heat exchanger 95, e.g. for obtaining a less complicated system.

The drying system 80 shown in FIG. 1 further includes a natural gas heater 97, optionally serving as a back-up heater, and a solar heater 98 functioning as burners heating the feeding gas flow F5 for feeding the bead regenerator device 6. Optionally, the system is provided with either the gas heater, the solar heater or another heater, e.g. based on geothermal energy. As an example, a solar panel heater with condenser can be applied for heating the feeding gas flow F5 up to circa 250 degrees Celsius.

Advantageously, the drying system 80 shown in FIG. 1 also includes a gas inflow port 99 and a gas outflow port 100 for inducing a drying gas flow F7 through the product compartment 19, thereby enhancing the drying efficiency of the system. In the embodiment, the system 80 further includes a fourth fan 101 flowing the drying gas flow F7, e.g. including ambient air, into the bead compartment 3, through the gas permeable partitioning 84 and through the product compartment 19 towards the gas outflow port 100. In the shown embodiment, the system further includes a fifth fan 102 inducing the drying gas flow F7 to flow via the gas outflow port 100 outwardly from the product compartment 19. Preferably, the drying gas flow mainly flows in a horizontal direction in the bead compartment 3 and the product compartment 19 thereby adding drying efficiency. More preferably, the gas inflow port 99 and/or the gas outflow port 100 extend along a substantial. height portion of the bead compartment 3 and/or the product compartment 19, respectively, thereby further increasing the drying efficiency. However, the temperature of the beads drops when applying the drying gas flow F7 thereby reducing the bead efficiency. By setting the flow rate of the drying gas flow F7, a drying capacity of the drying system 80 can be influenced, thereby controlling the drying process in terms of energy and quality of the dried product. In a more simplified drying system, the drying chamber 81 is not provided with gas inflow and outflow ports, and no additional drying air flow is induced.

In the shown embodiment, the system 80 further includes a product processing structure at least partially reflecting the hopping structure at the bead side. The system 80 comprises a wet product container 17, also called fresh product hopper, and a dried product container 21, also called final product hopper. Additionally, the drying chamber 19 includes a product inflow opening 103 downstream to the fresh product hopper 17 for flowing a wet product, via the product inflow opening 103, into the product compartment 19. The drying chamber further includes a product discharge opening 104 upstream to the final product hopper 21 for flowing a dried product from the product compartment 19, via the product discharge opening 104, into the dried product container. By applying the hopping structure at the product side, a bulk product can be dried continuously and efficiently. Generally, the moisture level of the products reduces during their stay in the product compartment 19. In principle, the system can be implemented without product hoppers. Then, alternatively, the product compartment 19 can be provided with a door or hatch providing access to said product compartment 19 for placing or removing a product to be dried in said product compartment 19.

The system 80 shown in FIG. 1 further comprises a product flow control mechanism for controlling a product inflow into the product compartment 19 and a product outflow from the product compartment 19 outwardly. The product flow control mechanism includes a product inflow valve 18 arranged upstream to the product inflow opening 103 and a product discharge valve 20 arranged downstream to the product discharge opening 104. The control unit 91 described above operates the product valves 18, 20. However, alternatively, a separate control unit 91 is applied for operating the product valves 18, 20.

Again, the product valves 18, 20 can be implemented as revolving sluices having the advantage that a gastight construction can be provided so that any interaction between product and surrounding air is minimized. Preferably, the control unit 91 is programmable to set a desired level of product or product particles in the product compartment 19. Then, the control unit 91 can be arranged to control the set level of product or product particles by regulating a product flow into the product compartment 19, i.e. by timely opening and closing, respectively, the product inflow valve 103. In a specific embodiment, the product inflow valve can be free flowing such that the product compartment 19 is always completely filled.

Similarly, the control unit 91 may be programmable to set a desired dryness or moisture degree of the product or the product particles. Then, the control unit 91 can be arranged to control the set dryness degree of the discharged product or product particles by regulating a product discharge flow, i.e. by timely opening and closing, respectively, the product discharge valve 104. Then, it can be counteracted that the product or the product particles are over-dried or under-dried. As an example, the product discharge flow can be reduced when the discharged products have not reached the set dryness degree, i.e. are not dry enough. In a specific embodiment, the product discharge valve is speed controlled such that the product is sufficiently dried, but not over-dried.

In the described system 80, beads and products, or bead particles and product particles, are transported from and to containers, hoppers and compartments via mainly stationary structures such as passive feeding lines or discharge lines, exploiting the gravity force exerted on the particles, or active feeding lines such as conveyor belts. Generally, the transporting structures are arranged for moving particles in one way only, downstream, during operation of the system. As an example, the dry bead hopper 1 and the fresh product hopper 17 are connected to the bead compartment 3 and the product compartment 19, respectively, via a bead feeding line 105 and a product feeding line 106, respectively. Similarly, the wet bead hopper 5 and the final product hopper 21 are connected to the bead compartment 3 and the product compartment 19, respectively, via a bead discharge line 107 and a product discharge line 108, respectively. In the respective feeding line, the inflow valve and inflow opening are located, either upstream or downstream to each other. Similarly, in the respective discharge line, the discharge valve and discharge opening are located, either upstream or downstream.

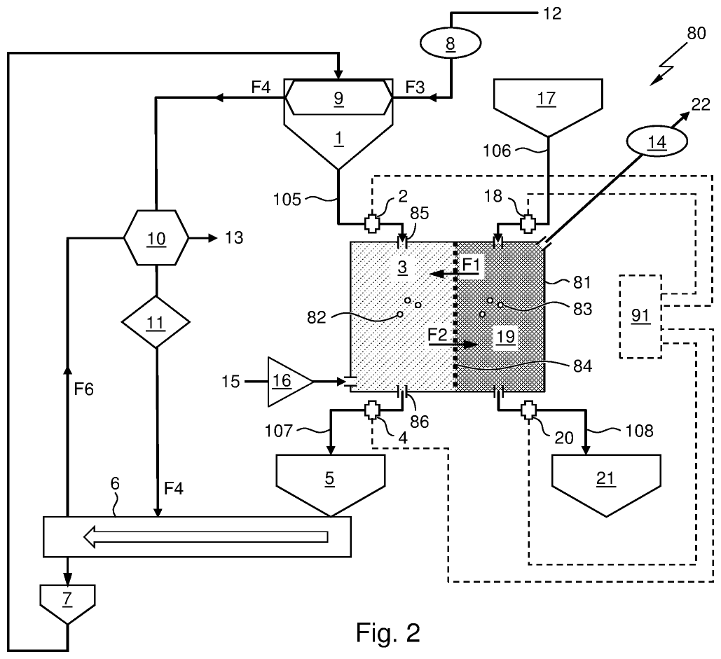

FIG. 2 shows a schematic view of a second embodiment of a drying system 80 according to the invention. Here, the third heat exchanger 10 is arranged for pre-heating an exhausted gas flow F4 from the first heat exchanger 9, not a fresh gas flow. The gas flow F4 heated in the third heat exchanger 11 is further heated by a single burner 11 for feeding the bead regenerator device 6. In the system shown in FIG. 2, the exhausted gas flow F4 is not used for pre-heating the saturated beads in the saturated bead hopper 5. In a further embodiment, the exhausted gas flow F4 may be split in a first gas portion to be heated for feeding the bead regenerator device 6 and a second gas portion for pre-heating the saturated beads in the saturated bead hopper 5. Further, in the system shown in FIG. 2, the feedback line 92 includes an additional hopper for storage of regenerated beads that are fed to the dry beads hopper 1 at a later stage. In principle, the additional hopper 7 can also be applied in the system shown in FIG. 1.

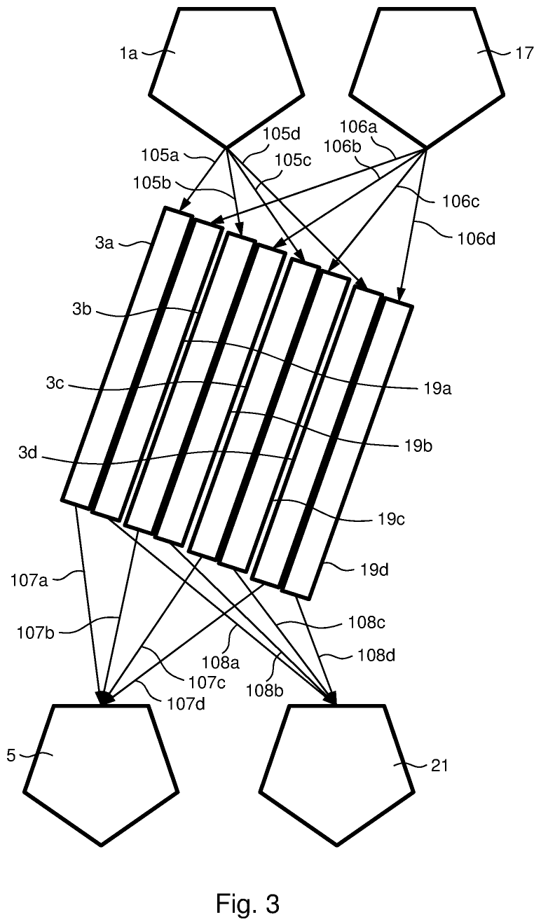

FIG. 3 shows a schematic partial of a third embodiment of a drying system according to the invention. Here, the system comprises again a dry bead hopper 1, a wet bead hopper 5, a fresh product hopper 17 and a final product hopper 21. Further, the system has a multiple number of drying chambers arranged in parallel, each drying chamber including a bead compartment 3a-d, a product compartment 19a-d, an air permeable partitioning separating the bead compartment 3a-d from the respective product compartment 19a-d, a bead inflow opening and a bead discharge opening, wherein a multiple number of bead inflow openings are arranged downstream to the dry bead hopper 1, via respective bead feeding lines 105a-d, and wherein a multiple number of bead discharge openings are located upstream to the wet bead hopper 5, via respective bead discharge lines 107a-d. Similarly, the product compartments 19a-d are arranged downstream to the fresh product hopper 17, via respective product feeding lines 106a-d, and upstream to the final product hopper 21, via respective product discharge lines 108a-d.

By providing a multiple number of drying chambers, arranged in parallel, the drying capacity of the drying system improves significantly.

Preferably, the bead particles are zeolite particles.

The term “zeolite” refers to a family of micro-porous hydrated aluminosilicate minerals. More than 150 zeolite types have been synthesized and 48 naturally occurring zeolites are known. Zeolites have an “open” structure that can accommodate a wide variety of cations, such as Na+, K+, Ca2+, Mg2+ and others. These positive ions are rather loosely held and can readily be exchanged for others in a contact solution. Some of the more common mineral zeolites are: Amicite, Analcime, Barrerite, Bellbergite, Bikitaite, Boggsite, Brewsterite, Chabazite, Clinoptilolite, Cowlesite, Dachiardite, Edingtonite, Epistilbite, Erionite, Faujasite, Ferrierite, Garronite, Gismoncline, Gmelinite, Gobbinsite, Gonnarclite, Goosecreekite, Harmotome, Herschelite, Heulandite, Laumontite, Levyne, Maricopaite, Mazzite, Merlinoite, Mesolite, Montesommaite, Mordenite, Natrolite, Offretite, Paranatrolite, Paulingite, Pentasil, Perlialite, Phillipsite, Pollucite, Scolecite, Sodium Dachiardite, Stellerite, Stilbite, Tetranatrolite, Thomsonite, Tschernichite, Wairakite, Wellsite, Willhendersonite and Yugawaralite, all of which are equally suitable for use in the present invention. An example mineral formula is: Na₂Al₂Si₃O₁₀-2H₂O, the formula for natrolite. Naturally occurring zeolites are rarely pure and are contaminated to varying degrees by other minerals, metals, quartz or other zeolites. For this reason, naturally occurring zeolites are less preferred in many applications where uniformity and purity are essential, yet such impure zeolites are very suitable for the present application.

The term zeolite includes reference to zeolite granules, zeolite beads and zeolite particles. Example of commercially available zeolites are; Linde Type A (LTA), Linde Types X and Y (Al-rich and Si-rich FAU), Silicalite-1 and ZSM-5 (MFI), and Linde Type B (zeolite P) (GIS). Other commercially available synthetic zeolites include Beta (BEA), Linde Type F (EDI), Linde Type L (LTL), Linde Type W (MER), SSZ-32 (MTT), BRZ® (clinoptilolite). All are aluminosilicates. Further, Linde type A zeolite (NaA, KA, CaA), also referred to by the three-letter code LTA (Linde Type A) zeolites, or the 3A, 4A and/or 5A type can be used. The size of the zeolite particles as used herein is not particularly limited in aspects of the present invention.

In all cases zeolites can take up water from moisture or water vapour in a gas. Zeolites can hold up to circa 35% or more of their weight in water. By choosing the pore size of the zeolite such that the pores are e.g. about 4 ångström, the zeolite is merely capable of absorbing water (H₂O) having a size of circa 2.7 ångström, no other substances or at least hardly no other substances, thereby rendering the zeolite particles extremely apt and efficient for the purpose of absorbing water.

In the product compartment 19, humid air can be dried, during operation of the system 80, e.g. for the purpose of drying seeds, thus providing a drying process with minimal or no impact on a food and/or nutritional value and/or color of the product to be dried.

The term “seeds” refers to any live seed, e.g. live seeds that are used for the generation of progeny plants grown from the seeds when seeded, sowed or planted in or on a soil or suitable growth substratum. In fact, any seed can be used in the method of the invention. Particularly useful are seeds of wheat, oat, corn (mais), barley, rye, millet, rice, soy, rapeseed, linseed (flax), sunflower, carrot, black salsify, runner bean, goa bean, asparagus pea or winged bean, haricot bean, climbing bean or pole bean, snap bean, broad bean or field bean, garden pea or green pea, lupin, tomato, pepper, melon, pumpkin, cucumber, egg plant, zucchini, onion, leek, lettuce, endive, spinach, corn salad, gherkin, (red) cabbage, savoy cabbage, pointed cabbage, Chinese cabbage, pak-choi (bok choy), cauliflower, Brussels sprouts, sugar beet, beetroot, kohlrabi, chicory, artichoke, asparagus, broccoli, celeriac, celery, radish, grass and spices.

However, humid air can also be applied for other purposes, e.g. in climate control systems for conditioning air in buildings. In this respect it is noted that a humidity level can be conditioned below circa 35% Rh so that metabolic activities are kept at a minimum level, thereby reducing or even eliminating any influence of bacteria, fungi and/or insects.

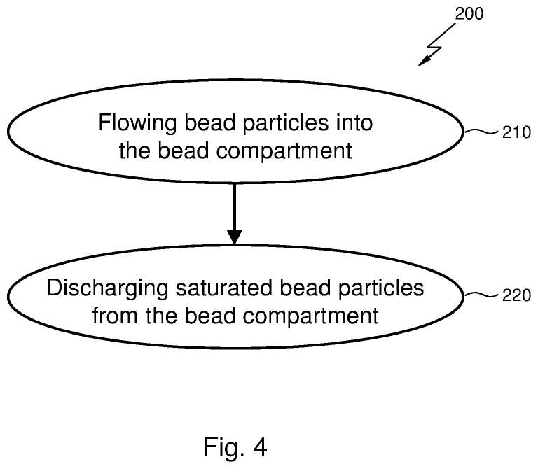

FIG. 4 shows a flow chart of steps of a method 200 for drying a product using a drying system described above. The method 200 comprises a step of flowing 210 bead particles into the bead compartment for drying the drying compartment, and a step of discharging 220 saturated bead particles from the bead compartment for regeneration.

The steps of flowing bead particles into and discharging saturated bead particles from the bead compartment can be executed using dedicated hardware structures, such as FPGA and/or ASIC components. Otherwise, the method can also at least partially be performed using a computer program product comprising instructions for causing a processor of a computer system or a control unit to perform the above described steps of the method according to the invention. All steps can in principle be performed on a single processor. However it is noted that at least one step can be performed on a separate processor. As an example, the drying modules can each be controlled by a separate processor.

Also the step of controlling a set level of bead particles in the bead compartment, a set level of product particles in the product compartment, a set saturation degree of discharged particles and/or a set dryness degree of a discharged product can be performed on hardware structures or using a computer program product.

The invention is not restricted to the embodiments described above. It will be understood that many variants are possible.

In this context it is noted that the product compartment accommodating the product to be dried can be implemented as another type of a drying compartment, e.g. as air flow channel for drying air that is passing through said channel. Then, the dried air can be used for drying articles at another location to which said dried air is flown. Alternatively, the dried air can be used for other purposes, e.g. for conditioning air in buildings. Especially, the air in the drying compartment can be dried by inducing a drying gas flow F7 from the bead compartment, via the gas permeable partitioning 84, into the drying compartment.

Generally, the drying system is arranged for drying wet, moistened or humidified products, such as moistened solid particles, e.g. seeds, grain and other commodities, split peas or nuts, or a gas such as humid air, e.g. for the purpose of drying air that is flown through agricultural products such as seeds or for another purpose such as conditioning air in buildings.

These and other embodiments will be apparent for the person skilled in the art and are considered to fall within the scope of the invention as defined in the following claims. For the purpose of clarity and a concise description features are described herein as part of the same or separate embodiments. However, it will be appreciated that the scope of the invention may include embodiments having combinations of all or some of the features described.

1. A drying system for drying a product, comprising a drying chamber including a bead compartment for accommodating bead particles, a drying compartment and a gas permeable partitioning separating the bead compartment from the drying compartment, wherein the drying chamber further includes a bead inflow opening for flowing dry bead particles into the bead compartment and a bead discharge opening for flowing saturated bead particles from the bead compartment outwardly.

2. The drying system according to claim 1, further comprising a dry bead container arranged upstream to the bead inflow opening, a saturated bead container arranged downstream to the bead discharge opening and a bead regenerator device arranged downstream to the saturated bead container.

3. The drying system according to claim 2, further comprising a feedback line transporting regenerated beads from the bead regenerator device to the dry bead container.

4. The drying system according to claim 2, wherein the dry bead container is provided with a first heat exchanger for cooling dry beads, using a gas flow.

5. The drying system according to claim 2, wherein the saturated bead container comprises a second heat exchanger for heating saturated beads using an exhausted gas flow from the first heat exchanger.

6. The drying system according to claim 4, comprising a third heat exchanger tor pre-baling a gas flow for feeding the bead regenerator device, using a heated gas flow from the bead regenerator device.

7. The drying system according to claim 6, wherein the third heat exchanger is arranged for pre-heating a fresh gas flow or an exhausted gas flow from the first heat exchanger.

8. The drying system according to claim 2, further comprising a burner heating a gas flow for feeding the bead regenerator device.

9. The drying system according to claim 1, wherein the drying chamber is provided with a gas inflow port and a gas outflow port for inducing a gas flow through the drying compartment.

10. The drying system according to claim 1, wherein the drying compartment includes a product compartment that is arranged for accommodating a product to be dried.

11. The drying system according to claim 10, further comprising a wet product container and a dried product container, wherein the drying chamber further includes a product inflow opening downstream to the wet product container for flowing a wet product, via the product inflow opening, into the product compartment, and wherein the drying chamber further includes a product discharge opening upstream to the dried product container for flowing a dried product from the product compartment, via the product discharge opening, into the dried product container.

12. The drying system according to claim 1, comprising a multiple number of drying chambers arranged in parallel, each dry ing chamber including a bead compartment, a drying compartment including a product compartment, an air permeable partitioning separating the bead compartment from the drying compartment, a bead inflow opening downstream and a bead discharge opening, wherein a multiple number of bead inflow openings are arranged downstream to the dry bead container and wherein a multiple number of bead discharge openings are located upstream to the saturated bead container.

13. The method for drying a product using the drying system according to claim 1, comprising a step of flowing bead particles into the bead compartment for drying the drying compartment, and a step of discharging saturated bead particles from the bead compartment for regeneration.

14. The method according to claim 13, wherein a set level of bead particles in the bead compartment is controlled by regulating a bead flow into the bead compartment.

15. The method according to claim 13, wherein a set saturation degree of discharged particles is controlled by regulating a bead discharge flow.

16. A non-transitory computer program product for operating the drying system according to claim 1, the computer program product comprising computer readable code for causing a processor to perform the step of controlling a flow of bead particles into the bead compartment for drying the drying compartment, and a step of controlling a discharge flow of saturated bead particles from the bead compartment for regeneration.

17. The method according to claim 13, therein a set level of product particles in the product compartment is controlled by regulatinga product low into the product compartment.

18. The method according to claim 13, wherein a set dryness degree a discharged product is controlled by regulating a product discharge flow.

19. The method according to claim 14, wherein a set level of product particles in the product compartment is controlled by regulating a product flow into the product compartment.

20. The method according to claim 15, wherein a set dryness degree of a discharged product is controlled by regulating a product discharge flow.
